(19) United States
(12) Patent Application Publication
(10) Pub. No.: US 2025/0257297 A1
(43) Pub. Date: Aug. 14, 2025

(54) RAPID METHOD OF PRODUCING ALCOHOL-FREE, NON-ALCOHOLIC AND ALCOHOLIC BEER

(71) Applicant: CERIA, INC., Arvada, CO (US)

(72) Inventor: Keith VILLA, Arvada, CO (US)

(21) Appl. No.: 18/857,289

(22) PCT Filed: Apr. 20, 2023
(86) PCT No.: PCT/US2023/019287

§ 371 Date: Oct. 16, 2024

Related U.S. Application Data
(60) Provisional application No. 63/333,464, filed on Apr. 21, 2022.
(60) Provisional application No. 63/343,524, filed on May 18, 2022.
(60) Provisional application No. 63/460,801, filed on Apr. 20, 2023.

(51) Int. Cl. C12C 12/04; A23L 2/38; A23L 2/60; C12G 3/025; C12G 3/026

(52) U.S. Cl. CPC C12C 12/04; A23L 2/382; A23L 2/60; C12G 3/025; C12G 3/026

(57) ABSTRACT

A rapid method of brewing malt beverages having 0.00-0.49% alcohol by volume, with the use of yeast in aerobic or anaerobic conditions. The yeast is inactivated by boiling after undergoing fermentative (minimal yeast contact time) growth, during either aerobic or anaerobic conditions. Aspects of the beverage such as sweetness, aldehyde content, flavor-positive components, pH, mouthfeel and heat are controlled to emulate popular styles of beer. The beverage may be fortified with alcohol or rapidly fully fermented to create alcoholic malt beverages with greater than 0.49% alcohol by volume. The beverage may also be fortified with substances such as cannabis, terpenes, cannabinoids, cannabidiols (CBDs), synthetic cannabinoids, mushrooms or peyote to change the psychoactive or physiological properties. Kombucha, hard seltzer, wine or spirits can also be produced using this method in a rapid time frame.

### FIELD

The present disclosure is directed to a rapid method of producing an alcohol-free beverage containing 0% alcohol by volume, and a non-alcoholic beverage containing up to 0.5% alcohol by volume. The disclosure additionally teaches production of alcoholic beverages in a rapid time frame by addition of alcohol (liquid, powdered or in other form), or by fermentation.

### BACKGROUND

There is currently a widespread consumer interest in non-alcoholic beverages, including beer-taste beverages. These “non-alcoholic” beverages typically have some residual alcohol, generally less than 0.5% alcohol by volume (ABV).

Traditional alcohol containing malt beverages are produced whereby yeast converts the glucose in a malt extract (wort), into ethyl alcohol and carbon dioxide gas (CO₂), resulting in the alcohol content and carbonation. The fermentation process starts when cooled wort is transferred to a fermenting vessel and yeast is added. This occurs in an anaerobic environment and takes two to six weeks to produce the final product.

Some non-alcoholic beverages currently available are produced by suppressing the fermentation process, thereby reducing the amount of alcohol produced yet still retaining beer flavors produced during the fermentation process. This is typically referred to as arrested fermentation.

Other non-alcoholic beverages are produced by removing alcohol from the final product, or eliminating the fermentation step entirely. Beer flavors can be provided by other means.

Presently disclosed is a method to produce an alcohol-free or non-alcoholic beverage by combining pre-made or brewed malt extract (wort) and yeast, with or without maltodextrin or other dextrinous compounds (adjuncts), with or without hops, flavor-active materials such as spices, psychoactive materials, and/or physiologically active materials, in an aerobic or anaerobic environment, followed by heating to eliminate or control residual alcohol and flavor by evaporation. Also disclosed is a method to produce an alcoholic beverage by combining pre-made or brewed malt (wort) and yeast, with or without maltodextrin or other dextrinous compounds (adjuncts), with or without hops, flavor-active materials such as spices, psychoactive materials, and/or physiologically active materials, in an aerobic or anaerobic environment, followed by heating to control flavor and alcohol content.

### BRIEF DESCRIPTION OF THE DRAWINGS

FIG. 1 shows the optimal RE: DE target for simulating malt beverage body profiles. RE % (Real Extract % weight/weight) increases in heavier beer types, while DE (Dextrose equivalent or sweetness) increases to a lesser extent. A balance between RE and DE is critical to achieve the desired beer taste.

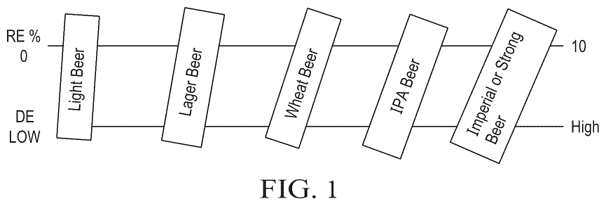

FIG. 2 shows a comparison of two methods of producing alcohol free (AF), non-alcoholic (NA) and alcoholic malt beverages in a rapid time frame.

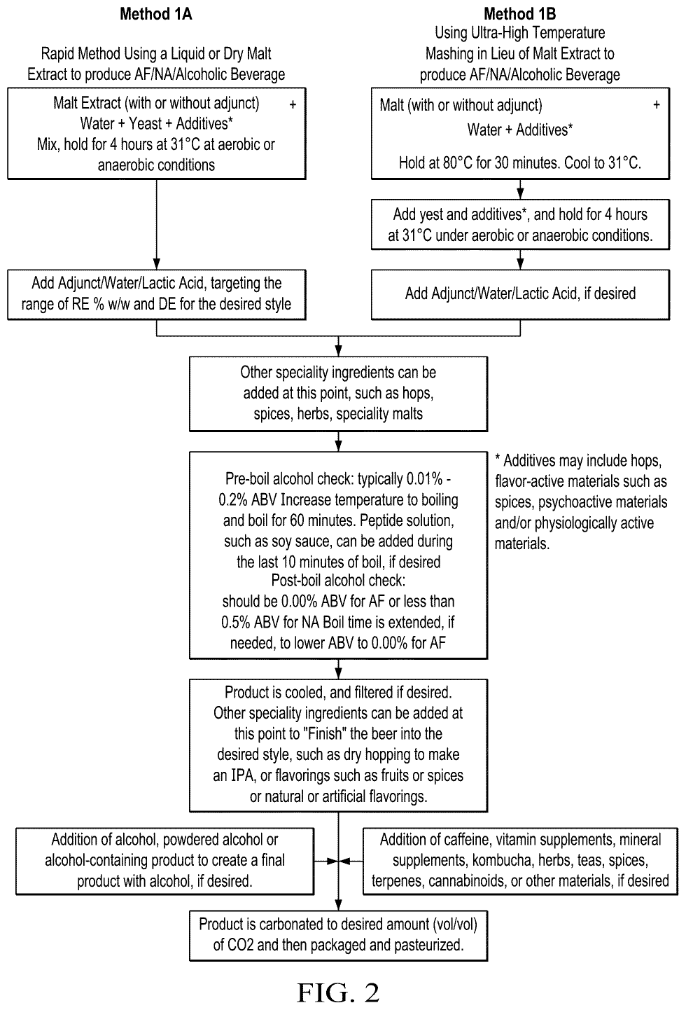

FIG. 3 shows a comparison of three methods of producing an alcoholic malt beverage in a rapid time frame by a fermentation process.

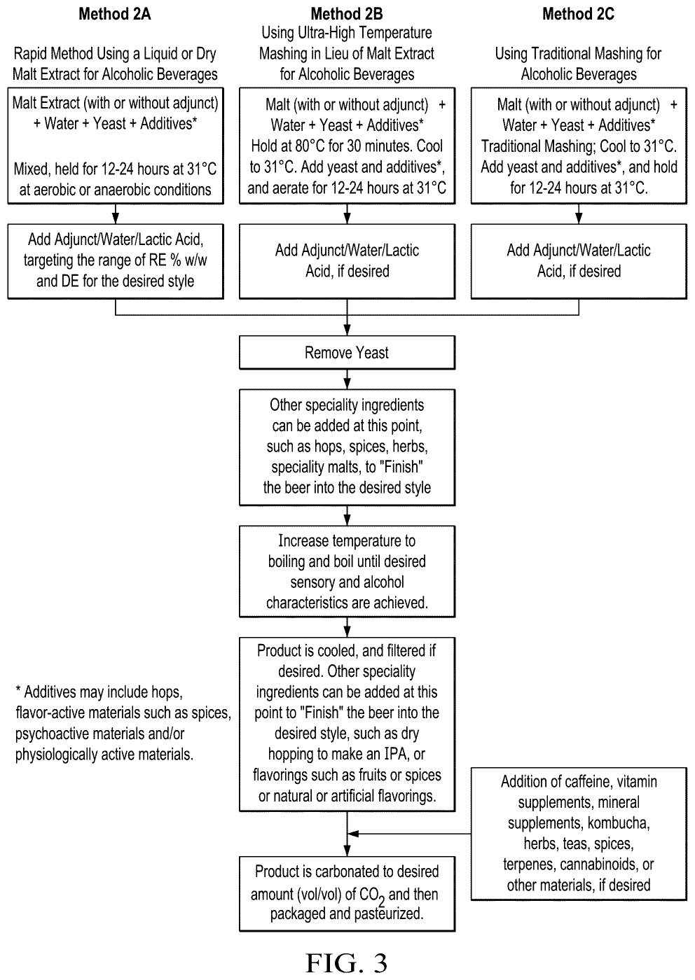

FIG. 4 shows how different select volatile organic components are removed by boiling the wort. Unfavorable volatile organic aromas are removed while favorable volatile organic aromas are retained.

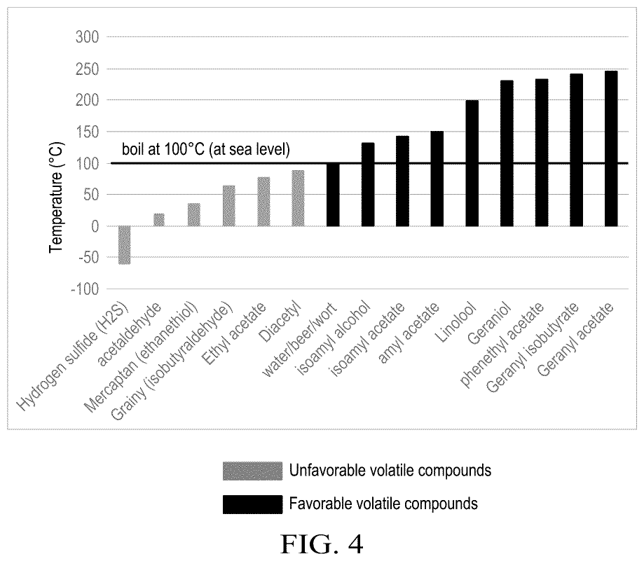

FIG. 5 shows a diagram of a traditional brewing method that takes two to six weeks and results in a fully fermented malt beverage.

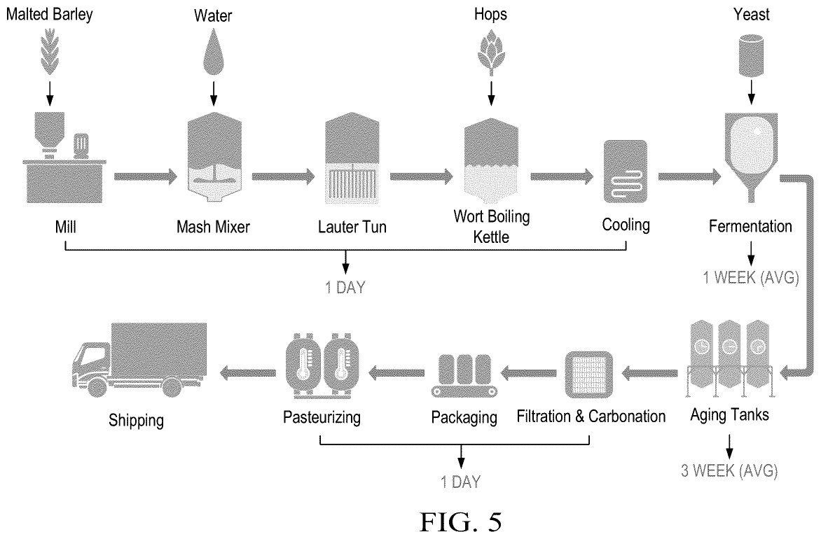

FIG. 6 shows a diagram of a one to two-day “rapid” brewing method for alcohol-free, non-alcoholic or alcoholic malt beverages.

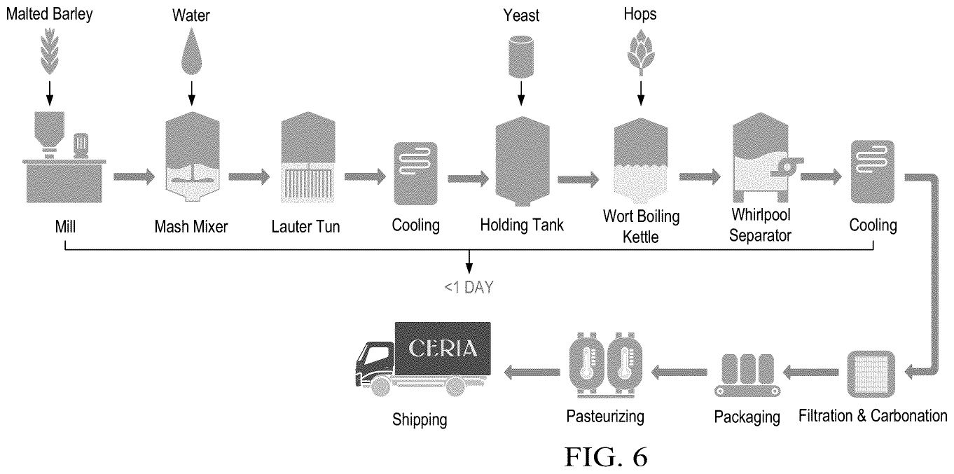

### SUMMARY

Traditionally, the flavors of many malt flavored beer-type beverages originate during alcoholic fermentation of the brewing ingredients by the introduction of yeast. Provided is a method to produce a zero, partially or fully fermented malt beverage, where the flavor components are provided by malts and yeast (with or without hops, flavor-active materials such as spices, psychoactive materials, physiologically active materials, and/or other flavor components), resulting in a beverage with 0.0% ABV, less than 0.5% ABV, or higher ABV, as measured by an Anton-Paar instrument or other industry standard as would be known by one with skill in the art.

In one embodiment is a method for producing a zero to partially fermented alcohol-free or non-alcoholic malt beverage (made with minimal yeast contact time), comprising the steps of constructing the base (consisting of malt extract and water) and adding yeast (with or without maltodextrin or other dextrinous compounds (adjunct)), and with or without hops, flavor-active materials such as spices, psychoactive materials, and/or physiologically active materials, under aerobic or anaerobic conditions. The growth of yeast produces compounds, such as esters, associated with the desired flavor of beer while metabolizing and/or removing aldehyde compounds. Controlling the acidity of the mixture is done by the addition of a food-grade acid. Controlling the “mouthfeel” of the product is done by boiling the malt/yeast/hops mixture (which releases peptides), and finally adding a small amount of warming agent to simulate the physiological effect of alcohol during consumption. An example of a warming agent is isothiocyanate which can be added in synthetic form or by adding plants that contain isothiocyanate. This embodiment may also incorporate a rapid production of an alcoholic malt beverage by either adding powdered or liquid alcohol or by extending the yeast contact time then boiling to control the alcohol and flavor levels.

In one embodiment is a method for producing a zero to partially fermented alcohol-free or non-alcoholic malt beverage (made with minimal yeast contact time) by mashing, which involves the steps of brewing the wort, consisting of malt and water (with or without maltodextrin or other dextrinous compounds (adjuncts)), with or without hops, flavor-active materials such as spices, psychoactive materials, and/or physiologically active materials, combined at ultra-high temperatures, followed by cooling and the addition of yeast, under aerobic or anaerobic conditions. The growth of yeast produces compounds, such as esters, associated with the flavor of beer while metabolizing and/or removing aldehyde compounds. Controlling the acidity of the mixture is done by the addition of a food-grade acid. Controlling the “mouthfeel” of the product is done by boiling the malt/yeast/hops mixture (which releases peptides), and finally adding a small amount of warming agent to simulate the effect of alcohol. An example of a warming agent is isothiocyanate which can be added in synthetic form or by adding plants that contain isothiocyanate. Alternatively, this embodiment may also result in a rapid production of an alcoholic malt beverage by adding powdered or liquid alcohol, or by ultra high temperature or traditional temperature mashing, and extending the yeast contact time and boiling to control the alcohol and flavor levels.

In one embodiment is a rapid method of producing a fully fermented alcoholic malt beverage.

In one embodiment, the flavor of the product (beverage) is finished by the addition of hop oils, specialty malts, natural or artificial flavors, or any combination of fruits, herbs, spices, or vegetables to create the flavor of a desired beer or other new product. Additionally, other compounds can be added, including cannabis, terpenes, cannabinoids, cannabidiols (CBDs), synthetic cannabinoids, mushrooms, peyote and others which provide both flavor and a potential physiological or mind-altering reaction.

In one embodiment, the method creates a 0.00% ABV product, which may be more desirable than a 0-0.5% ABV product. It is also possible to achieve varying levels of alcohol in the final product depending on the total contact time between the fermentable materials and the yeast, combined with the length of time the mixture is held at or above the boiling point of ethanol (78.4° C.). This may aid in the evaporation of unwanted alcohol. It is also possible to add a defined amount of alcohol following the production of the 0.0%-0.5% ABV product.

In one embodiment, yeast addition takes place on the “hot” side of the brewery and not the “cold” side, i.e. at approximately room temperature in the brewhouse and not in the colder, sterile fermentation cellars. Yeast type can include traditional brewer's yeast (e.g. Saccharomyces cerevisiae and Saccharomyces uvarum) but can also include other types of yeast such as baker's yeast, wine yeast, champagne yeast, distiller's yeast, and any other type of domesticated, wild or industrial yeast and combinations thereof. Other microorganisms which are incapable of fermenting sugar can also be used, and can include S. ludwigii, Pichia kluyveri, Zygosaccharomyces rouxii and Torula delbrueckii any genetically modified organism (GMO) and combinations thereof.

In one embodiment, the method creates a beer produced in as much as 95% less time than conventional brewing methods.

In one embodiment the method creates a beer produced in the timeframe selected from the group consisting of 7 days, 6 days, 5 days, 4 days, 3 days, 2 days, 1 day, 12 hours, 8 hours, 6 hours and less than 4 hours.

In one embodiment, the method creates a beer using up to 25% less space than conventional brewing methods.

In one embodiment, the method creates a beer with up to 20% lower cost than conventional brewing methods.

In one embodiment, tetrahydrocannabinol (THC) is added to the beer at a concentration selected from the group consisting of 0.0001%, 0.0005%, 0.001%, 0.0015%, 0.002%, 0.0025%, 0.003%, 0.0035%, 0.004%, 0.0045%, 0.005% up to 1%, 2%, 3%, 4%, 5%, 6%, 7%, 8%, 9%, 10%, 11%, 12%, 13%, 14%, and 15% by weight.

In one embodiment, tetrahydrocannabinol (THC) can be used to infuse malt beverages. In one embodiment, tetrahydrocannabinol (THC) can be used to infuse malt beverages, with or without CBD.

In one embodiment, alcohol-free, non-alcoholic or alcoholic wine can be produced. In one embodiment, alcohol-free, non-alcoholic or alcoholic wine can be produced and infused with THC or CBD.

In one embodiment, additions selected from the group consisting of zinc, oxygen, fatty acids, temperature, yeast concentrations and/or other ingredients or factors, and combinations thereof can be altered to control the final flavor profile of the finished malt beverage (alcohol free, non-alcoholic or alcoholic).

Genetically modified or classically modified yeast or other microorganisms, which possess genes and traits from other organisms, are also taught in this process.

Yeast addition is done in sterile or non-sterile conditions, since it is added in relatively large quantities, thus out-competing other microorganisms which might be present. The mixture undergoes boiling for sterilization.

Yeast is used to decrease the flavor of aldehydes (a contributor to undesirable “worty” flavor) with adequate aeration and temperature, and not under cold, sterile, oxygen-free conditions, as is typically done in the fermentation cellars. In one embodiment, yeast, or a mixture of yeast with other microorganisms, is used to change the flavor, aroma, mouthfeel or texture of the beverage product. Yeast-produced flavor compounds include esters and terpenoids such as isoamyl acetate, phenethyl acetate, amyl acetate and citronellol, which all have boiling points above 100° C., and are therefore not boiled off (evaporated) during typical brewing and boiling procedures. These esters and flavor compounds remain in the final product to provide beer-like flavor and aroma. Additionally, when yeast is boiled, this unicellular microorganism will rupture and the amino acids and small proteins released provide a positive mouthfeel, texture and body, similar to a traditional fermented beer that contains alcohol.

The “mouthfeel” (texture or fullness) is also controlled by including additional proteinaceous peptides to simulate the authentic mouthfeel of alcoholic beer.

The boiling process kills the yeast, allowing the use of any type of yeast or microorganism. In contrast, typical breweries are often opposed to bringing a foreign or wild yeast into their brewing facility, for fear of cross-contamination with the predominant yeast strain they might use. In one embodiment, the process removes the threat of contaminants of yeast strains to the brewing process.

Body and sweetness can be adjusted to emulate the body and sweetness of any beer style.

In one embodiment, the entire process is rapid and can produce a finished product in as little as one day, as opposed to 2 to 6 weeks for the production of a traditional alcoholic, alcohol-free or non-alcoholic malt beverage.

Alcohol can also be added to the finished product, which results in a traditional, alcohol-containing product made in a rapid time frame.

In one embodiment, the physiological warming effect of alcohol after consumption is emulated by the use of a small amount of allyl isothiocyanate which is introduced by adding plants from the plant family Brassicaceae, such as horseradish, into the brewing mixture. In one embodiment, physiological warming effects are produced by other natural and artificial means including but not limited to the addition of natural or synthetic gingerols, shogaols, paradols or zingerone from members of the plant family Zingiberaceae, such as ginger or Grains of Paradise and combinations thereof.

### Definitions

As used herein, the term “body” refers to the fullness of the flavor of a beverage. Descriptors range from watery or characterless, to satiating or thick.

As used herein, the phrase “ultra-high” refers to mashing temperatures between 75-100° C. In one embodiment mashing temperatures range from 75-85° C. In one embodiment mashing temperatures range from 80-100° C. In one embodiment mashing temperatures range from 76-86° C. In one embodiment an ultra high temperature refers to 80° C. A mashing temperature refers to temperatures required to optimize enzymatic activity inherent to the mash and/or malt.

As used herein, the phrase “aldehyde content” refers to the amount of aldehydes present in the final product. Aldehyde content is decreased below a sensory threshold. This is a term well known in the field.

As used herein, the phrases “yeast exposure” and “yeast contact time” refer to allowing yeast cells to metabolize organic substrates.

As used herein, the term “mouthfeel” refers to the textural attributes of a beverage, those which produce a tactile sensation in the mouth.

As used herein, the phrase “simulated alcohol warming” refers to the use of various compounds to mimic the effect alcoholic beverages have on heat receptors in the human body.

As used herein, the phrase “hop oil” refers to essential oils extracted from a hop flower or cone.

As used herein, the phrase “hop solution” refers to liquid extract or dry hop powders or dry hop pellets or natural hop flowers.

As used herein, the phrase “addition of alcohol” refers to adding alcohol, powdered alcohol or a high alcohol containing liquid to the end product to create an alcoholic or low alcoholic beverage. Additionally, alcohol may be added by controlling the yeast exposure (the amount of time the yeast is producing flavors and alcohol); extended exposure times result in the production of more flavors and a small amount of alcohol. This is balanced with boiling time to minimize the evaporation and loss of alcohol.

As used herein the phrase “% Real Extract” (% RE) is a measure of the gravity of the beverage, where gravity refers to the amount of solids (this includes fermentable sugars) present in a mixture. RE is expressed in a weight/weight ratio, where w/w represents the content of dissolved solids in a beverage.

As used herein the phrase “Dextrose Equivalent” (DE) refers to the percent of mono- and di-saccharides present in a mixture and is related to the relative sweetness.

As used herein the phrase “partially fermented” refers to a mixture produced by yeast undergoing aerobic respiration, or minimal fermentative growth.

As used herein the phrase “0% alcohol” means 0% alcohol, in one embodiment 0.0% alcohol, in one embodiment 0.00% alcohol, all of which are referred to as alcohol free (AF), as defined by Alcohol and Tobacco Tax and Trade Bureau (TTB) or other government agency wherein alcohol cannot be detected. In one embodiment 0.01 to less than 0.5% is considered non-alcoholic (NA), as defined by TTB. Alcohol is measured by Anton-Paar instrument or other industry standard, to measure alcohol percentage on volume to volume (v/v) percentage. Alternatively, this can be measured by weight to weight (w/w). Alcohol by volume is known as ABV.

As used herein the term “yeast” refers to a eukaryotic, single-celled microorganism classified as members of the fungus kingdom.

As used herein the term “malt extract” refers to sugars extracted from germinated grain.

As used herein the term “mixing” refers to stirring by shaking or agitating.

As used herein the term “aerating” refers to the addition of air by means such as mixing or the bubbling of air or oxygen through the mixture.

As used herein the term “maltodextrin” refers to a water soluble powder or liquid with a neutral taste produced from vegetable starch, including but not limited to, rice, corn, wheat or tapioca.

As used herein the term “mineral supplement” refers to minerals including but not limited to salts and electrolytes.

As used herein the term “deg P” refers to a measurement used to quantify the concentration of extract (mainly sugars derived from malt but also including other soluble material in wort) as a percentage by weight. Also commonly referred to as Degrees Plato.

As used herein, the term “seltzer” refers to carbonated water.

As used herein, the terms “dextrinous compound” or “adjuncts” refer to a source of non-malt, non-fermentable sugars.

As used herein, the term “protein” refers to natural or synthetic nitrogenous organic compounds that have large molecules composed of one or more long chains of amino acids, including whey, vegetable proteins or animal proteins.

As used herein, the term “mash” refers to mixing ground malt and water and heating the mixture.

As used herein, the term “base” refers to a mixture of malt extract (dry or liquid) and water.

As used herein, the term “traditional temperature mashing” refers to a mashing mixture held at temperatures in the range of 40-75° C.

As used herein, the term “until fermentation is complete” refers to the end of the yeast fermentation cycle where zero or negligible fermentable material is present in the medium; or it can refer to a brewer removing the brewer's yeast at a specific time during fermentation when a desired end of fermentation endpoint is reached, or it can refer to increasing the temperature of the medium to result in killing the brewer's yeast when a desired fermentation endpoint is reached.

As used herein, the term “holding time” is defined as the total time in seconds, minutes, hours or days that is allowed for a desired action or reaction to be completed.

As used herein, the term “holding temperature” is defined as the temperature, in degrees Fahrenheit or degrees Celsius, that the medium is held at in order for a desired action or reaction to take place.

### Embodiments

In one embodiment, a method for producing a beer-like malt alcohol-free or non-alcoholic beverage (containing 0.0% to 0.5% alcohol by volume, comprising the steps of constructing the malt base (malt extract plus water), with or without hops, flavor-active materials such as spices, psychoactive materials, and/or physiologically active materials; with zero to partial fermentation by yeast (with minimal contact time) and controlling the body and sweetness of the malt base by blending malt extract, maltodextrin or other dextrinous compounds. Step 1 consists of blending a mixture of malt extract (dry or liquid) with or without adjuncts, hops, flavor-active materials such as spices, psychoactive materials, and/or physiologically active materials; with water and yeast. This is held (with or without agitation), and aerated, if desired, for 4 hours. In one embodiment, this is held for 0 to 5 hours. In one embodiment, this is held for 0 to 12 hours. In one embodiment, this is held for 0 to 24 hours. In one embodiment, this is held for 0 hours to 1 week. In one embodiment, this is held for 0 hours to 2 weeks at 30° C. In one embodiment the temperature is 0 to 35° C. In one embodiment, the temperature is 0 to 75° C. Step 2 consists of the addition of maltodextrin or other dextrinous compounds (adjuncts) and water to achieve the desired % Real Extract (RE), and lactic acid and hop solution, if desired, to enhance flavoring. The total weight amount of malt extract plus maltodextrin or other dextrinous compound, is calculated based on the % RE of the alcoholic beer that is to be emulated. Typical beers have a finished % RE between 0.5-10% w/w, where w/w represents the content of dissolved solids in a beer. For example, an 8% w/w RE would require 8 grams of malt extract plus maltodextrin in a liquid product weighing 100 grams. Light beers have 0.5-2% w/w RE. Lagers and wheat-type beers have 3-6% w/w RE. Non-alcoholic or alcohol-free wheat-type beers target 5.4% w/w RE. India Pale Ales (IPAs) and heavier beers have 4-8% w/w RE. Non-alcoholic or alcohol-free IPAs target 7.5% w/w RE. By targeting these RE amounts, the body of the desired beer can be re-created with a mixture of malt extract and maltodextrin or other dextrinous compound and combinations thereof.

Sweetness of the final product is controlled by the ratio of malt extract (with or without other simple sugars) to maltodextrin, or other dextrinous compounds, in order to target a specific Dextrose Equivalent (DE). DE refers to the percent of mono- and disaccharides present and is related to the relative sweetness. Malt extract has a high level of simple sugars with a high relative sweetness (i.e. high DE). Conversely, maltodextrin has a low level of simple sugars with a low relative sweetness (i.e. not sweet). Any ratio of malt extract to maltodextrin can be used. In one embodiment a light (beer) beverage has a ratio of about 0.5-2% w/w RE to about 0.5-2% w/w DE. In one embodiment an IPA style (beer) beverage has a ratio of about 4-8% w/w RE to about 3-6% w/w DE. In one embodiment a wheat style (beer) beverage has a ratio of about 3-6% w/w RE to about 2-4% w/w DE.

In one embodiment described, RE is controlled in an all-grain brewing process using ultra-high mashing temperatures of 75-85° C. and up to 100° C. In one embodiment, brewer's mash mixture contains malted barley and water, with or without adjuncts, hops, flavor-active materials such as spices, psychoactive materials, and/or physiologically active materials. In one embodiment brewer's mash mixture contains malted or unmalted wheat (20-60%), oats (1-10%), rice (10-60%), corn (10-60%), rye (1-5%), triticale (5-20%) or any other grain including so called “ancient” grains such as amaranth, quinoa, sorghum, teff, and spelt. In one embodiment ancient grains are added from 1-50%. All additions are added as a weight percent of the total mash weight. In one embodiment starch (adjunct) is added in combination with a dextrinous compound (unfermentable, long-chain sugars). During the mash process, the mash mixture is heated to temperatures over 75° C. prior to boiling. In one embodiment temperatures during the mash process range from 75 to 100° C. In one embodiment 80° C. is used for production of RE with low fermentability and optimal body. In one embodiment the mash mixture is heated for 20 minutes. In one embodiment the mash mixture is heated for 15 to 20 minutes. In one embodiment the mash mixture is heated for 20 to 25 minutes. In one embodiment the mash mixture is heated for 25 to 30 minutes. In one embodiment the mash mixture is heated for 30 to 35 minutes. In one embodiment the mash mixture is heated for 35 to 40 minutes.

In one embodiment described, RE is controlled in an all-grain brewing process using traditional mashing temperatures and times. In one embodiment, brewer's mash mixture contains malted barley and water, with or without adjuncts, hops, flavor-active materials such as spices, psychoactive materials, and/or physiologically active materials. In one embodiment brewer's mash mixture contains malted or unmalted wheat (20-60%), oats (1-10%), rice (10-60%), corn (10-60%), rye (1-5%), triticale (5-20%) or any other grain including so called “ancient” grains such as amaranth, quinoa, sorghum, teff, and spelt. In one embodiment ancient grains are added from 1-50%. All additions are added as a weight percent of the total mash weight. In one embodiment starch (adjunct) is added in combination with a dextrinous compound (unfermentable, long-chain sugars).

In one embodiment, the method comprises decreasing aldehydes by yeast exposure. Unfermented beer (also called “wort”) has high amounts of flavor-active compounds, called aldehydes, which result in negative flavors if present in beers. Aldehydes are present in the malt extract fraction or malt fraction with or without adjuncts, hops, flavor-active materials such as spices, psychoactive materials, and/or physiologically active materials, and not in the maltodextrin fraction with or without hops, flavor-active materials such as spices, psychoactive materials, and/or physiologically active materials.

In one embodiment the wort (prepared with either a malt extract base or a brewed malt) with or without adjuncts, hops, flavor-active materials such as spices, psychoactive materials, and/or physiologically active materials, of the base is mixed with yeast and water and held at room temperature, in one embodiment held at a range of 0-35° C., in one embodiment held at a range from 0 to 75° C., in one embodiment held at a range between 30-65° C., for 0.00-5 hours, in one embodiment for 0 hours to 2 weeks, to decrease the aldehydes below their flavor threshold.

In one embodiment the wort (prepared with either a malt extract base or a brewed malt base), with or without adjuncts, hops, flavor-active materials such as spices, psychoactive materials, and/or physiologically active materials, or combinations thereof is mixed with yeast and water and held at room temperature, in one embodiment held at a range of 0-35° C., in one embodiment held at a range from 0 to 75° C., in one embodiment held at a range between 30-65° C., for 3-4 hours.

In one embodiment the wort (prepared with either a malt extract base or a brewed malt base), with or without adjuncts, hops, flavor-active materials such as spices, psychoactive materials, and/or physiologically active materials, is mixed with yeast and water and held at room temperature, in one embodiment held at a range of 0-35° C., in one embodiment held at a range from 0 to 75° C., in one embodiment held at a range between 30-65° C., for 2-4 hours.

In one embodiment the wort (prepared by either a malt extract base or a brewed malt base), with or without adjuncts, hops, flavor-active materials such as spices, psychoactive materials, and/or physiologically active materials, and combinations thereof is mixed with yeast and water and held at room temperature, in one embodiment held at a range of 0-35° C., in one embodiment held at a range from 0 to 75° C., in one embodiment held at a range between 30-65° C., for 0-2 hours.

In one embodiment the wort (prepared with either a malt extract base or a brewed malt base), with or without adjuncts, hops, flavor-active materials such as spices, psychoactive materials, and/or physiologically active materials and combinations thereof, is mixed with yeast and water and held at room temperature, in one embodiment held at a range of 0-35° C., in one embodiment held at a range from 0 to 75° C., in one embodiment held at a range between 30-65° C., for 4 hours. In one embodiment maltodextrin or other dextrinous compounds are added to brewer's yeast and is held at a temperature range of in one embodiment held at a range of 0-35° C., in one embodiment held at a range from 0 to 75° C., in one embodiment held at a range between 30-65° C.

In one embodiment the temperature range is from 28-35° C. In one embodiment the temperature range is from 31-32° C.

In one embodiment brewer's yeast is selected from the group consisting of Saccharomyces cerevisiae and Saccharomyces uvarum and combinations thereof.

In one embodiment, non-brewing yeast strains are used at temperatures ranging from 0-35° C. In one embodiment non-brewing yeast strains are used at temperatures exceeding 35° C. In one embodiment non-brewing yeast strains are used at temperatures as high as 75° C. In one embodiment the yeast strains are held at a range of 0-35° C., in one embodiment held at a range from 0 to 75° C., in one embodiment held at a range between 30-65° C.

In one embodiment additional yeast strains include, but are not limited to baker's yeast, wine yeast, champagne yeast, distiller's yeast, and any other type of domesticated, wild or industrial yeast and combinations thereof. In one embodiment additional microorganisms which are incapable of fermenting certain sugars are used, and can include Saccharomycodes ludwigii, Pichia kluyveri, Zygosaccharomyces rouxii and Torula delbrueckii or a genetically modified organism (GMO) and combinations thereof.

In one embodiment classically modified or genetically modified yeast or other microorganisms, which possess genes and traits from other organisms, are used.

In one embodiment, other microorganisms are used which work to decrease the negative flavor compounds in the wort mixture.

In one embodiment, the presence of yeast or other microorganisms results in the production of flavor-positive components such as esters and higher alcohols (alcohols with more than two carbon atoms) and the reduction or elimination of negative flavors. Many of these flavor-positive components have boiling points higher than 100° C., which is the temperature at which traditional brewhouse boiling occurs, and thus will survive the boiling step and be present in the finished product. These flavor-positive components add to the finished beer flavor of the final product. Constant stirring provides aeration and oxygen so that the yeast are active and will grow anaerobically or aerobically, therefore minimizing alcohol production during this time. Growth of the yeast additionally produces flavor-positive compounds and limits production of aldehydes. Aeration can also be achieved by other means such as bubbling of air or oxygen through the mixture. In one embodiment, solutions rich in unsaturated fatty acids, such as unsaturated vegetable oil, are used to provide nourishment to the yeast or other microorganisms. Sterility is not required since this mixture will be boiled; conditions may also include sterile techniques.

After holding the mixture for a range of 1-5 hours at 20-35° C., the malt fraction (with or without adjuncts, hops, flavor-active materials such as spices, psychoactive materials, and/or physiologically active materials) with yeast is added to the previously prepared maltodextrin solution (or other dextrinous compound) described above, at the appropriate RE concentration and the mixture is boiled for 0.1 minute or more to deactivate the yeast, boil off (evaporate) and remove any alcohol that might be produced, and to sterilize the solution.

In one embodiment, the boiling time is controlled to produce a desired amount of alcohol in the range of 0.00% to less than 0.49% ABV, or to 0.5% or more ABV, depending on the desired final level of alcohol in the product. In one embodiment a low alcohol beer product, defined by The Alcohol and Tobacco Tax and Trade Bureau (TTB) as having 0.5-2.5% ABV, is made with this process. In one embodiment this allows a brewer to demonstrate, if needed, that alcoholic fermentation may be allowed to occur in those instances where a demonstrated production of alcohol must take place in order for a product to be called a “beer”, or for a product to fall under the jurisdiction of one government agency (e.g. Food and Drug Administration) or another (e.g. TTB) in terms of required product labeling.

In one embodiment the pH of the extract is controlled. Lactic acid or any other food-grade acid, such as citric acid, phosphoric acid or an acidic preparation using acid-producing bacteria such as Lactobacillus delbrückii, L. brevis, L. acidophilus, L. lactis, Pediococcus damnosus (formerly called P. cerevisiae, and now classified as P. acidilactici), acidified malt or other acidified ingredients or materials, is used to decrease the pH to that of a finished beer, which ranges from about pH 3.0 to 6.5.

In one embodiment the “mouthfeel” is controlled by the addition of proteinaceous peptides. Mouthfeel is defined as a textural attribute of beer. This is controlled by boiling the yeast and malt mixture to kill and lyse the yeast cells, releasing yeast oligopeptides and polypeptides and thereby improving the mouthfeel of the product. Peptides can consist of oligopeptides (two to twenty amino acids in length) and polypeptides up to about 50 amino acids. Peptides larger than about 50 amino acids are known as proteins and generally do not survive the boiling step of the brewing process. In one embodiment peptides are added by the breakdown of larger proteins, either naturally, chemically or enzymatically.

In one embodiment preparations of fermented products are added to enrich the final alcohol-free or non-alcoholic beer product with proteinaceous peptides. In one embodiment these products include soy sauce (fermented wheat or soy) which uses a mold such as Aspergillus spp. to ferment, or bacteria such as Lactobacillus spp. to break down existing sugars into lactic acid. Typical use ranges from 0.1 to 50 or more milliliters fermented product per liter, to impart mouthfeel. In one embodiment the usage in non-alcoholic (beer) beverage is 1-5 mL per liter, while the preferred usage is 3 mL per liter. In one embodiment the usage in low-alcoholic (beer) beverage is 1-5 mL per liter, in one embodiment usage is 3 mL per liter. In one embodiment proteinaceous peptides from fermented products Miso, tauco, and kombucha are added.

In one embodiment to emulate the “heat” of alcohol a small amount of allyl isothiocyanate is added to the mixture. This can be introduced by adding synthetic or isolated allyl isothiocyanate, or by adding small amounts of plant material containing this compound. In one embodiment plants from the plant family Brassicaceae, classically referred to as Cruciferae, (mustard family) include horseradish, mustard seed, turnips, rutabaga, cabbage, kohlrabi, Brussel sprouts, cauliflower, broccoli and kale are added. Foods made from these plants, such as wasabi (made from horseradish and mustard seed), are used. Ranges from 0.1 to 1000 micrograms or more per liter can be used to induce heat reaction similar to that of alcohol warming. In one embodiment about 100 micrograms per liter are added to provide a mild warming effect similar to alcohol. Plants or foods are added to the mash mixture at any point after boiling to achieve the desired level of warming. As allyl isothiocyanate has a boiling point of 151° C., it will remain in solution and the boiling of the wort at 100° C. will not vaporize it. The temporary heat from allyl isothiocyanate is different than the burning, lingering heat of capsaicin from chili peppers. Warming effects can also be emulated by other natural and artificial means such as the addition of gingerols, shogaols, paradols or zingerone from members of the plant family Zingiberaceae, such as ginger or Grains of Paradise.

In one embodiment to create an IPA, appropriate hop oil or extracts are added for bitterness and other flavoring. Hop oil and extracts may be very concentrated and as little as 0.01 microgram or more than 100 mg per liter may be used depending on the original concentration of the oil or extract. In one embodiment the product is dry-hopped with hop material such as hop pellets, using as little as 0.01 gram per liter to more than 1000 grams per liter. In one embodiment specialty malts are added to emulate desired beer styles. These can be added as concentrated extracts or as milled malt. Additions may be as low as 0.01 gram per liter to more than 1000 grams per liter. Wheat malts may be added for wheat beer flavor. In one embodiment roasted malts are added for the flavors associated with stout beers. In one embodiment caramel malts are added for flavors associated with amber ales, and the like. In one embodiment natural and artificial flavors are added to the finished product to create other desired beer styles and new products, such as seltzers or kombuchas.

In one embodiment ingredients such as herbs, spices, teas, caffeine, protein, vitamin and mineral supplements, melatonin, juices, cannabis, terpenes, cannabinoids, cannabidiols, synthetic cannabinoids, mushrooms, psilocybin containing mushrooms, peyote, ayahuasca, mescaline and other items which provide flavoring or physiological and mind altering reactions are added to the finished product. In one embodiment the finished product is carbonated to desired levels, packaged and pasteurized. In one embodiment carbonation ranges from a natural level of about 1.5 vol/vol CO₂ to very high levels above 3.0 vol/vol CO₂.

In one embodiment the carbonation method is either natural carbonation or forced carbonation. Natural carbonation occurs during the short amount of time the yeast is allowed to ferment. Forced carbonation can be used to achieve a target level of 2.7, with a range between 1.5 vol/vol to 3.0 vol/vol or higher.

In one embodiment, alcohol-free or non-alcoholic products made by the described process are made into alcoholic products by the addition of alcohol. This is achieved by adding any product containing alcohol, or a high-alcohol containing product that was fermented (such as a high alcohol beer or wine), or a powdered alcohol product. This process allows for the production of an alcoholic beverage in a rapid time frame—typically less than 12 hours, compared to the traditional time frame of 2 to 6 weeks or more, resulting in significant savings in cost, labor and materials. Products made in this way resemble traditionally made products such as beer, wine, kombucha, hard seltzer, and the like.

Implementations may include one or more of the following features.
Method 1A: A method where the beverage produced contains 0% ABV, 0.01%, 0.02%, 0.03%, 0.04%, 0.45% up to 0.49% ABV, or 0.5% or more ABV. Malt extract (with or without adjuncts), water, yeast and/or other additives are mixed and aerated, if desired. The temperature of the mixture may be controlled so as not to exceed 35° C. The temperature of the mixture may be controlled in the range of 0-35° C. The temperature of the mixture may be controlled so as not to exceed 75° C.). The mixture is held for zero to 4 hours (range 0-5 hours, up to 2 weeks) aerobically or anaerobically, after which, maltodextrin or other dextrinous compounds (adjuncts), water and/or lactic acid are added, if desired. Hops, spices, herbs, specialty malts or combinations thereof, may also be added. The mixture is heated to boiling, and then cooled. The alcohol content is assessed prior to heating, or after heating or both. The amounts of malt extract and maltodextrin or other dextrinous compounds (adjuncts), are adjusted to change the body and sweetness of said beverage. The aldehyde content and/or flavor-positive components of said beverage are controlled by allowing zero to partial fermentation (with minimal yeast contact time) by yeast and boiling during production. The mouthfeel of said beverage is controlled by the addition of proteinaceous peptides. Following the addition of maltodextrin or other dextrinous compounds, a material may be added selected from the group that may include allyl isothiocyanate, gingerols, shogaols, paradols and zingerone. The flavor of said beverage is altered by the addition of a material selected from the group that may include hop oil, hop extract, specialty malt, natural flavor, artificial flavor and combinations thereof. The flavor of said beverage is altered by the addition of a material selected from the group that may include caffeine, protein, vitamin supplements, mineral supplements, kombucha, herbs, teas, spices, beer, wine, spirits, terpenes, cannabinoids, synthetic cannabinoids, mushrooms, psilocybin containing mushrooms, peyote, ayahuasca, mescaline and combinations thereof. The addition provides flavor and/or physiological and/or mind-altering reactions. Alcohol is added to the malt beverage to create alcoholic beer in a time frame that is more rapid than traditional methods or fermentation.
Method 1B: A method where the beverage produced contains 0.00% ABV, 0.01%, 0.02%, 0.03%, 0.04%, 0.45% up to 0.49% ABV, or 0.5% or more ABV. Malt, with or without adjuncts, is mixed with water, with or without hops, flavor-active materials such as spices, psychoactive materials, and/or physiologically active materials, and heated to at least 75° C. (range of 70-90° C.) for at least 20 minutes (range of 10-30 minutes); then cooled to 30° C. (range of 0-35° C.). Yeast is added, with or without adjuncts, hops, flavor-active materials such as spices, psychoactive materials, and/or physiologically active materials; and mixture is held for 4 hours (range 0-5 hours, or up to 2 weeks) aerobically or anaerobically. Adjunct, water and/or lactic acid is added, if desired. Hops, spices, herbs, specialty malts or combinations thereof, may be added. The mixture is heated to boiling, and then cooled. The alcohol content is assessed prior to heating, or after heating or both. The amount of malt extract and maltodextrin, or other dextrinous compounds, are adjusted to change the body and sweetness of said beverage. The aldehyde content and/or flavor-positive components of said beverage are controlled by allowing zero to partial fermentation (with minimal yeast contact time) by yeast and boiling during production. The mouthfeel of said beverage is controlled by the addition of proteinaceous peptides. Following malt addition, a material may be added selected from the group that may include allyl isothiocyanate, gingerols, shogaols, paradols and zingerone. The flavor of said beverage is altered by the addition of a material selected from the group that may include hop oil, hop extract, specialty malt, natural flavor, artificial flavor and combinations thereof. The flavor of said beverage is altered by the addition of a material selected from the group that may include caffeine, protein, vitamin supplements, mineral supplements, kombucha, herbs, teas, spices, beer, wine, spirits, terpenes, cannabinoids, synthetic cannabinoids, mushrooms, psilocybin containing mushrooms, peyote, ayahuasca, mescaline and combinations thereof. The addition provides flavor and/or physiological and/or mind-altering reactions. Alcohol is added to the malt beverage to create alcoholic beer in a time frame that is more rapid than traditional methods or fermentation.
Method 2A: A method where the beverage produced contains more than 0.5% ABV. Malt extract (with or without adjunct), water, yeast and/or other additives are mixed and aerated, if desired. The temperature of the mixture may be controlled so as not to exceed 35° C. The temperature of the mixture may be controlled in the range of 0-35° C. The temperature of the mixture may be controlled so as not to exceed 75° C.). The temperature is controlled for 12 hours (range 6-48 hours), aerobically or anaerobically, after which maltodextrin or other dextrinous compounds (adjuncts) hops, spices, herbs, specialty malts or combinations thereof, may be added. The yeast is removed from the mixture, then the mixture is heated to boiling, then cooled. The alcohol content is assessed prior to heating, or after heating or both. The amounts of malt extract and maltodextrin or other dextrinous compounds (adjuncts), are adjusted to change the body and sweetness of said beverage. The flavor of said beverage is altered by the addition of a material selected from the group that may include hop oil, hop extract, specialty malt, natural flavor, artificial flavor and combinations thereof. The flavor of said beverage is altered by the addition of a material selected from the group that may include caffeine, protein, vitamin supplements, mineral supplements, kombucha, herbs, teas, spices, beer, wine, spirits, terpenes, cannabinoids, synthetic cannabinoids, mushrooms, psilocybin containing mushrooms, peyote, ayahuasca, mescaline and combinations thereof. The addition provides flavor and/or physiological and/or mind-altering reactions. Fermentation time can be adjusted to control the desired amount of alcohol.
Method 2B: A method where the beverage produced contains more than 0.5% ABV. Malt, with or without adjuncts, is mixed with water, with or without hops, flavor-active materials such as spices, psychoactive materials, and/or physiologically active materials, and heated to at least 75° C. (range of 70-90° C.) for at least 20 minutes (range of 10-30 minutes); then cooled to 30° C. (range of 0-35° C.). Yeast is added, with or without adjuncts, hops, flavor-active materials such as spices, psychoactive materials, and/or physiologically active materials; and mixture is held for 12 hours (range 6-48 hours) aerobically or anaerobically. Adjunct, water and/or lactic acid is added, if desired. Hops, spices, herbs, specialty malts or combinations thereof, may be added. The yeast is removed from the mixture, then the mixture is heated to boiling, and then cooled. The alcohol content is assessed prior to heating, or after heating or both. The flavor of said beverage is altered by the addition of a material selected from the group that may include hop oil, hop extract, specialty malt, natural flavor, artificial flavor and combinations thereof. The flavor of said beverage is altered by the addition of a material selected from the group that may include caffeine, protein, vitamin supplements, mineral supplements, kombucha, herbs, teas, spices, beer, wine, spirits, terpenes, cannabinoids, synthetic cannabinoids, mushrooms, psilocybin containing mushrooms, peyote, ayahuasca, mescaline and combinations thereof. The addition provides flavor and/or physiological and/or mind-altering reactions. Fermentation time can be adjusted to control the desired amount of alcohol.
Method 2C: A method where the beverage produced contains more than 0.5% ABV. Malt, with or without adjuncts, is mixed with water, with or without hops, flavor-active materials such as spices, psychoactive materials, and/or physiologically active materials, and heated to traditional mashing temperatures (range of 40-75° C.); then cooled to 30° C. (range of 0-35° C.). Yeast is added, with or without adjuncts, hops, flavor-active materials such as spices, psychoactive materials, and/or physiologically active materials; and mixture is held for 12 hours (range 6-48 hours), aerobically or anaerobically. Adjunct, water and/or lactic acid is added, if desired. Hops, spices, herbs, specialty malts or combinations thereof, may be added. The yeast is removed from the mixture, then the mixture is heated to boiling, and then cooled. The alcohol content is assessed prior to heating, or after heating or both. The flavor of said beverage is altered by the addition of a material selected from the group that may include hop oil, hop extract, specialty malt, natural flavor, artificial flavor and combinations thereof. The flavor of said beverage is altered by the addition of a material selected from the group that may include caffeine, protein, vitamin supplements, mineral supplements, kombucha, herbs, teas, spices, beer, wine, spirits, terpenes, cannabinoids, synthetic cannabinoids, mushrooms, psilocybin containing mushrooms, peyote, ayahuasca, mescaline and combinations thereof. The addition provides flavor and/or physiological and/or mind-altering reactions. Fermentation time can be adjusted to control the desired amount of alcohol.

Table 1 is a summary of rapid brewing method examples 1A/1B. Table 2 is a summary of rapid brewing method examples 2A/2B/2C.

TABLE 1

| | Belgian-Style White Ale | | IPA | |
|---|---|---|---|---|
| | | Method 1B | | Method 1B |
| | Method 1A | Ultra-High | Method 1A | Ultra-High |
| | Liquid or Dry | Temperature | Liquid or Dry | Temperature |
| | Malt Extract | Mashing | Malt Extract | Mashing |
| Rapid | Example 1 | Example 3 | Example 5 | Example 7 |
| AF (0.00% | | | | |
| ABV) or | | | | |
| NA (<0.5% | | | | |
| ABV) | | | | |
| Rapid Alcoholic | Example 2 | Example 4 | Example 6 | Example 8 |
| by Addition of | | | | |
| Alcohol | | | | |

TABLE 2

| | Belgian-Style White Ale | | | IPA | | |
|---|---|---|---|---|---|---|
| | Method | Method | | Method | Method | |
| | 2A | 2B | Method | 2A | 2B | Method |
| | Liquid or | Ultra-High | 2C | Liquid or | Ultra-High | 2C |
| | Dry Malt | Temperature | Traditional | Dry Malt | Temperature | Traditional |
| | Extract | Mashing | Mashing | Extract | Mashing | Mashing |
| Rapid | Example 9 | Example 10 | Example 11 | Example 12 | Example 13 | Example 14 |
| Alcoholic by | | | | | | |
| Fermentation | | | | | | |

### EXAMPLE 1

### Method 1A; AF/NA Belgian-Style White Ale by Malt Extract

(Malt Extract and Maltodextrin Mixing)
0.00% ABV Rapid Non-Alcohol Production
Belgian Style White per-bbl Brew

| Ingredient | QTY | |
|---|---|---|
| Malt Extract | 1-5 | lbs |
| Maltodextrin | 1-5 | lbs |
| Wheat Extract | 1-5 | lbs |
| Oats | 0.5-5 | lbs |
| Lactic Acid, 88% | 50-100 | ml |
| Brewers Yeast | 15-30 | gm |
| Hops | 50-200 | gm |
| Orange Peel | 200-1000 | gm/bbl |
| Coriander | 100-500 | gm/bbl |

Mix grain, malt extracts and maltodextrin with 40 gallons water, at 30° C.
Add yeast and aerate and mix for 4 hours at 30° C.
Add lactic acid
Add hops
Increase temperature to boil; Boil 60 minutes
Add hops, orange peel and coriander
Whirlpool or filter to clarify, if desired
Transfer to tank at 4° C.; should be 5.0-6.0 deg P and pH 4.15-4.35
Filter, carbonate and package

### EXAMPLE 2

### Method 1A; Alcoholic Belgian-Style White Ale by Addition of Alcohol

(Malt Extract and Maltodextrin Mixing)
Belgian Style White per-bbl Brew

| Ingredient | QTY | |
|---|---|---|
| Malt Extract | 1-5 | lbs |
| Maltodextrin | 1-5 | lbs |
| Wheat Extract | 1-5 | lbs |
| Oats | 0.5-5 | lbs |
| Lactic Acid, 88% | 50-100 | ml |
| Brewers Yeast | 15-30 | gm |
| Hops | 50-200 | gm |
| Orange Peel | 200-1000 | gm/bbl |
| Coriander | 100-500 | gm/bbl |

Mix grain, malt extracts and maltodextrin with 40 gallons water, at 30° C.
Add yeast and aerate and mix for 4 hours at 30° C.
Add lactic acid
Add hops
Increase temperature to boil; Boil 60 minutes
Add hops, orange peel and coriander
Whirlpool or filter to clarify, if desired
Transfer to tank at 4° C.; should be 2.0-3.0 deg P and pH 4.15-4.35
Add alcohol in the form of liquid or powder to desired % Alcohol by Volume.
Filter, carbonate and package

### EXAMPLE 3

### Method 1B; AF/NA Belgian-Style White Ale by UHT Mashing

(Ultra-High Temperature (UHT) Mashing)
0.00% ABV Rapid Non-Alcohol Production
Belgian Style White per-bbl Brew

| Ingredient | QTY | |
|---|---|---|
| Malt or | 15-25 | lbs |
| Maltodextrin | | |
| Wheat | 10-20 | lbs |
| Oats | 1-10 | lbs |
| Lactic Acid, 88% | 50-100 | ml |
| Brewers Yeast | 15-30 | gm |
| Hops | 50-200 | gm |
| Orange Peel | 200-1000 | gm/bbl |
| Coriander | 100-500 | gm/bbl |

Mash with 40 gallons water, at 80° C.; Hold at 80° C. for 30 minutes.
Lauter to brewkettle and sparge grains with 80° C. water
Cool to 30° C.
Add yeast and aerate and mix for 4 hours at 30° C.
Add lactic acid
Add hops
Increase temperature to boil; Boil 60 minutes
Add hops, orange peel and coriander
Whirlpool or filter to clarify, if desired
Transfer to tank at 4° C.; should be 5.0-6.0 deg P and pH 4.15-4.35
Filter, carbonate and package

### EXAMPLE 4

### Method 1B; Belgian-Style White Ale by UHT Mashing and Addition of Alcohol

(Ultra-High Temperature (UHT) Mashing)
Belgian Style White per-bbl Brew

| Ingredient | QTY | |
|---|---|---|
| Malt | 15-25 | lbs |
| Maltodextrin | 15-25 | lbs |
| Wheat | 10-20 | lbs |
| Oats | 1-10 | lbs |
| Lactic Acid, 88% | 50-100 | ml |
| Brewers Yeast | 15-30 | gm |
| Hops | 50-200 | gm |
| Orange Peel | 200-1000 | gm/bbl |
| Coriander | 100-500 | gm/bbl |

Mash with 40 gallons water, at 80° C.; Hold at 80° C. for 30 minutes. Lauter to brewkettle and sparge grains with 80° C. water
Cool to 30° C.
Add yeast and aerate and mix for 4 hours at 30° C.
Add lactic acid
Add hops
Increase temperature to boil; Boil 60 minutes
Add hops, orange peel and coriander
Whirlpool or filter to clarify, if desired
Transfer to tank at 4° C.; should be 2.0-3.0 deg P and pH 4.15-4.35
Add alcohol in the form of liquid or powder to desired % Alcohol by Volume
Filter, carbonate and package

### EXAMPLE 5

### Method 1A; AF/NA IPA by Malt Extract

(Malt Extract and Maltodextrin Mixing)
0.00% ABV Rapid Non-Alcohol Production
IPA per-bbl Brew

| Ingredient | QTY | |
|---|---|---|
| Malt Extract | 2-12 | lbs |
| Maltodextrin | 2-12 | lbs |
| Lactic Acid, 88% | 50-100 | ml |
| Brewers Yeast | 15-30 | gm |
| Hops | 100-300 | gm |
| Dry hop | 500-1000 | gm/bbl |

Mix malt extract and maltodextrin with 40 gallons water, at 30° C.
Add yeast and aerate and mix for 4 hours at 30° C.
Add lactic acid
Add hops
Increase temperature to boil; Boil 60 minutes
Add hops
Whirlpool or filter to clarify
Transfer to tank at 4° C.; should be 6.5-7 deg P and pH 4.15-4.35
Dry hop
Filter, carbonate and package

### EXAMPLE 6

### Method 1A; Alcoholic IPA by Addition of Alcohol

(Malt Extract and Maltodextrin Mixing)
IPA per-bbl Brew

| Ingredient | QTY | |
|---|---|---|
| Malt Extract | 2-12 | lbs |
| Maltodextrin | 2-12 | lbs |
| Lactic Acid, 88% | 50-100 | ml |
| Brewers Yeast | 15-30 | gm |
| Hops | 100-300 | gm |
| Dry hop | 500-1000 | gm/bbl |

Mix malt extract and maltodextrin with 40 gallons water, at 30° C.
Add yeast and aerate and mix for 4 hours at 30° C.
Add lactic acid
Add hops
Increase temperature to boil; Boil 60 minutes
Add hops
Whirlpool or filter to clarify
Transfer to tank at 4° C.; should be 6.5-7 deg P and pH 4.15-4.35
Add alcohol in the form of liquid or powder to desired % Alcohol by Volume
Dry hop
Filter, carbonate and package

### EXAMPLE 7

### Method 1B; AF/NA IPA by UHT Mashing

(Ultra-High Temperature (UHT) Mashing)
0.00% ABV Rapid Non-Alcohol Production
IPA per-bbl Brew

| Ingredient | QTY | |
|---|---|---|
| Malt | 25-35 | lbs |
| Maltodextrin | 25-35 | lbs |
| Lactic Acid, 88% | 50-100 | ml |
| Brewers Yeast | 15-30 | gm |
| Hops | 100-300 | gm |
| Dry hop | 500-1000 | gm/bbl |

Mash with 40 gallons water, at 80° C.; Hold at 80° C. for 30 minutes.
Lauter to brewkettle and sparge grains with 80° C. water
Cool to 30° C.
Add yeast and aerate and mix for 4 hours at 30° C.
Add lactic acid
Add hops
Increase temperature to boil; Boil 60 minutes
Add hops
Whirlpool or filter to clarify
Transfer to tank at 4° C.; should be 6.5-7 deg P and pH 4.15-4.35
Dry hop
Filter, carbonate and package

### EXAMPLE 8

### Method 1B; Alcoholic IPA by UHT Mashing and Addition of Alcohol

(Ultra-High Temperature (UHT) Mashing)
IPA per-bbl Brew

| Ingredient | QTY | |
|---|---|---|
| Malt | 25-35 | lbs |
| Maltodextrin | 25-35 | lbs |
| Lactic Acid, 88% | 50-100 | ml |
| Brewers Yeast | 15-30 | gm |
| Hops | 100-300 | gm |
| Dry hop | 500-1000 | gm/bbl |

Mash with 40 gallons water, at 80° C.; Hold at 80° C. for 30 minutes.
Lauter to brewkettle and sparge grains with 80° C. water
Cool to 30° C.
Add yeast and aerate and mix for 4 hours at 30° C.
Add lactic acid
Add hops
Increase temperature to boil; Boil 60 minutes
Add hops
Whirlpool or filter to clarify
Transfer to tank at 4° C.; should be 6.5-7 deg P and pH 4.15-4.35
Add alcohol in the form of liquid or powder to desired % Alcohol by Volume
Dry hop
Filter, carbonate and package

### EXAMPLE 9

### Method 2A; Alcoholic Belgian-Style White Ale by Malt Extract Mixing and Fermentation

(Malt Extract and Maltodextrin Mixing)
Belgian Style White per-bbl Brew

| Ingredient | QTY | |
|---|---|---|
| Malt Extract | 2-7 | lbs |
| Maltodextrin | 2-7 | lbs |
| Wheat Extract | 2-7 | lbs |
| Oats | 1-4 | lbs |
| Brewers Yeast | 15-45 | gm |
| Hops | 50-200 | gm |
| Orange Peel | 200-1000 | gm/bbl |
| Coriander | 100-500 | gm/bbl |

Mix grain, hops, malt extracts and maltodextrin with 40 gallons water, at 30° C.
Add yeast and aerate and mix for 12 hours at 30° C., until fermentation is complete
Remove yeast
Increase temperature to boil
Boil until desired levels of alcohol and volatile organic aromas are achieved
Add hops, orange peel and coriander during boil
Whirlpool or filter to clarify, if desired
Transfer to tank at 4° C.; should be 2.0-3.0 deg P and 4.0-5.5% ABV
Filter, carbonate and package

### EXAMPLE 10

### Method 2B; Alcoholic Belgian-Style White Ale by UHT Mashing and Fermentation

(Ultra High Temperature (UHT) Mashing)
Belgian Style White per-bbl Brew

| Ingredient | QTY | |
|---|---|---|
| Malt | 20-30 | lbs |
| Maltodextrin | 20-30 | lbs |
| Wheat | 15-25 | lbs |
| Oats | 1-10 | lbs |
| Lactic Acid, 88% | 50-100 | ml |
| Brewers Yeast | 15-30 | gm |
| Hops | 50-200 | gm |
| Orange Peel | 200-1000 | gm/bbl |
| Coriander | 100-500 | gm/bbl |

Mash with 40 gallons water, at 80° C.; Hold at 80° C. for 30 minutes.
Lauter to brewkettle and sparge grains with 75° C. water
Cool to 30° C.
Add yeast and aerate and mix for 12 hours at 30° C., until fermentation is complete
Remove yeast
Increase temperature to boil
Boil until desired levels of alcohol and volatile organic aromas are achieved
Add hops, coriander and orange peel during boil
Whirlpool or filter to clarify, if desired
Transfer to tank at 4° C.; should be 2.0-3.0 deg P and 4.0-5.5% ABV
Filter, carbonate and package

### EXAMPLE 11

### Method 2C; Alcoholic Belgian-Style White Ale, Traditional Mashing

(Traditional Mashing)
Belgian Style White per-bbl Brew

| Ingredient | QTY | |
|---|---|---|
| Malt | 20-30 | lbs |
| Maltodextrin | 20-30 | lbs |
| Wheat | 15-25 | lbs |
| Oats | 1-10 | lbs |
| Lactic Acid, 88% | 50-100 | ml |
| Brewers Yeast | 15-30 | gm |
| Hops | 50-200 | gm |
| Orange Peel | 200-1000 | gm/bbl |
| Coriander | 100-500 | gm/bbl |

Mash with 40 gallons water, at 60° C.; Hold at 60° C. for 60 minutes.
Raise to 75° C.; Hold at 75° C. for 10 minutes.
Lauter to brewkettle and sparge grains with 75° C. water
Cool to 30° C.
Add yeast and aerate and mix for 12 hours at 30° C., until fermentation is complete
Remove yeast
Increase temperature to boil
Boil until desired levels of alcohol and volatile organic aromas are achieved
Add hops, coriander and orange peel during boil
Whirlpool or filter to clarify, if desired
Transfer to tank at 4° C.; should be 2.0-3.0 deg P and 4.0-5.5% ABV
Filter, carbonate and package

### EXAMPLE 12

### Method 2A; Alcoholic IPA by Malt Extract Mixing and Fermenting

(Malt Extract and Maltodextrin Mixing)
IPA per-bbl Brew

| Ingredient | QTY | |
|---|---|---|
| Malt Extract | 4-20 | lbs |
| Maltodextrin | 4-20 | lbs |
| Lactic Acid, 88% | 50-100 | ml |
| Brewers Yeast | 15-45 | gm |
| Hops | 100-300 | gm |
| Dry hop | 500-1000 | gm/bbl |

Mix malt extract and maltodextrin with 40 gallons water, at 30° C.
Add yeast and aerate and mix for 12 hours at 30° C., until fermentation is complete
Increase temperature to boil
Boil until desired levels of alcohol and volatile organic aromas are achieved
Add hops during boil
Whirlpool or filter to clarify
Transfer to tank at 4° C.; should be 3.0-4.5 deg P and 6-7.5% ABV
Dry hop
Filter, carbonate and package

### EXAMPLE 13

### Method 2B; Alcoholic IPA by UHT Mashing/Fermentation

(Ultra-High Temperature (UHT) Mashing)
IPA per-bbl Brew

| Ingredient | QTY | |
|---|---|---|
| Malt | 20-30 | lbs |
| Corn syrup | 10-15 | lbs |
| Lactic Acid, 88% | 50-100 | ml |
| Brewers Yeast | 15-30 | gm |
| Hops | 100-300 | gm |
| Dry hop | 500-1000 | gm/bbl |

Mash malt and corn syrup (dextrinous compound) with 40 gallons water, at 80° C.; Hold at 80° C. for 30 minutes.
Lauter to brewkettle and sparge grains with 80° C. water
Cool to 30° C.
Add yeast and aerate and mix for 12 hours at 30° C., until fermentation is complete
Remove yeast
Increase temperature to boil
Boil until desired levels of alcohol and volatile organic aromas are achieved
Add hops
Whirlpool or filter to clarify
Transfer to tank at 4° C.; should be 6.5-7 deg P and pH 4.15-4.35
Dry hop
Filter, carbonate and package

### EXAMPLE 14

### Method 2C; Alcoholic IPA by Traditional Mashing/Fermentation

(Traditional Mashing)
IPA per-bbl Brew

| Ingredient | QTY | |
|---|---|---|
| Malt | 20-30 | lbs |
| Corn syrup | 10-15 | lbs |
| Lactic Acid, 88% | 50-100 | ml |
| Brewers Yeast | 15-30 | gm |
| Hops | 100-300 | gm |
| Dry hop | 500-1000 | gm/bbl |

Mash with 40 gallons water, at 60° C.; Hold at 60° C. for 60 minutes.
Raise to 75° C.; Hold at 75° C. for 10 minutes.
Lauter to brewkettle and sparge grains with 75° C. water
Cool to 30° C.
Add yeast and aerate and mix for 12 hours at 30° C., until fermentation is complete
Remove yeast
Increase temperature to boil
Boil until desired levels of alcohol and volatile organic aromas are achieved
Add hops
Whirlpool or filter to clarify
Transfer to tank at 4° C.; should be 6.5-7 deg P and pH 4.15-4.35
Dry hop
Filter, carbonate and package

It will be apparent to those skilled in the art that various modifications and variations can be made in the methods and compositions of the present disclosure without departing from the spirit or scope of the disclosure.

What is claimed is:

1. A method for producing a beverage comprising the steps of:
a. Mixing a base of malt extract and water with yeast; with or without adjuncts, hops, flavor-active materials such as spices, psychoactive materials, and/or physiologically active materials;
b. Holding the mixture, aerobically or anaerobically, for 0.00 hours to 2 weeks at a range of 0-75° C.;
c. Adding maltodextrin or other dextrinous compounds (adjuncts), water, lactic acid and hop solution to the mixture;
d. Heating the mixture to boiling; and then
e. Cooling.

2. The method according to claim 1, wherein the beverage contains 0.00% alcohol to 0.49% ABV by controlling the boil time.

3. The method according to claims 1 to 2, wherein the amount of malt extract and adjuncts are adjusted to change the body and sweetness of said beverage.

4. The method according to claims 1 to 3, wherein additional ingredients consisting of hops, spices, herbs, specialty malts or combinations thereof are added to said mixture.

5. The method according to claims 1 to 4, wherein the alcohol content of said mixture is assessed prior to heating, or after heating or both.

6. The method according to claims 1 to 5 wherein, the aldehyde content and/or flavor-positive components of said beverage are controlled by allowing zero to partial fermentation by yeast during production.

7. The method according to claims 1 to 6, wherein the mouthfeel of said beverage is controlled by the addition of proteinaceous peptides.

8. The method according to claims 1 to 7, wherein following the addition of maltodextrin or other adjuncts, a material selected from the group consisting of allyl isothiocyanate, gingerols, shogaols, paradols, zingerone and combinations thereof, is added to said mixture.

9. The method according to claims 1 to 8, wherein the flavor of said beverage is altered by the addition of a material selected from the group consisting of hop oil, hop extract, specialty malt, natural flavor, artifical flavor and combinations thereof.

10. The method according to claims 1 to 9, wherein the flavor and/or psychoactive or physiological makeup of said beverage is altered by the addition of a material selected from the group consisting of caffeine, protein, vitamin supplements, mineral supplements, kombucha, herbs, teas, spices, beer, wine, spirits, terpenes, cannabinoids, synthetic cannabinoids, mushrooms, psilocybin containing mushrooms, peyote, ayahuasca, mescaline and combinations thereof.

11. The method according to claim 10 wherein the addition provides flavor and/or physiological and/or mind altering reactions to said beverage.

12. The method according to claims 1 to 11, wherein alcohol is added to said beverage to create alcoholic beer in a time frame that is more rapid than traditional methods of fermentation.

13. The method according to claims 1 to 11, wherein beer, wine, kombucha, seltzer and other alcohol-free, non-alcoholic or alcoholic mixtures or beverages are produced in a time frame that is more rapid than traditional methods.

14. A method for producing a beverage comprising the steps of:
a. Mixing malt and water, with or without adjuncts, hops, flavor-active materials such as spices, psychoactive materials, and/or physiologically active materials;
b. Heating the mixture to at least 70° C. for at least 20 minutes, then cooling to a range of 0-35° C.);
c. Adding yeast, with or without hops, flavor-active materials such as spices, psychoactive materials, and/or physiologically active materials and combinations thereof;
d. Holding the mixture, aerobically or anaerobically, for 0.00 hours to 2 weeks at a range of 0-75° C.;
e. Adding maltodextrin or other adjuncts, water, lactic acid and hop solution to the mixture;
f. Heating the mixture to boiling; and then
g. Cooling said mixture.

15. The method according to claim 14, wherein the beverage contains 0.00% to 0.49% alcohol ABV by controlling the boil time.

16. The method according to claim 14, wherein the beverage contains 0.50% alcohol—15% alcohol ABV by controlling the boil time to achieve a desired final level of alcohol in the finished product.

17. The method according to claims 14 to 16, wherein adding additional ingredients consisting of hops, spices, herbs, specialty malts or combinations thereof are added to said mixture.

18. The method according to claims 14 to 17, wherein the alcohol content of said mixture is assessed prior to heating, or after heating or both.

19. The method according to claims 14 to 18 wherein, the aldehyde content and/or flavor-positive components of said mixture are controlled by allowing zero to partial fermentation by yeast during production.

20. The method according to claims 14 to 19, wherein the mouthfeel of said mixture or beverage is controlled by the addition of proteinaceous peptides.

21. The method according to claims 14 to 20, wherein following maltodextrin or other dextrinous compound addition, adding a material selected from the group consisting of allyl isothiocyanate, gingerols, shogaols, paradols and zingerone to said mixture or beverage.

22. The method according to claims 14 to 21, wherein the flavor of said mixture or beverage is altered by the addition of a material selected from the group consisting of hop oil, hop extract, specialty malt, natural flavor, artifical flavor and combinations thereof.

23. The method according to claims 14 to 22, wherein the flavor and/or psychoactive or physiological makeup of said mixture or beverage is altered by the addition of a material selected from the group consisting of caffeine, protein, vitamin supplements, mineral supplements, kombucha, herbs, teas, spices, beer, wine, spirits, terpenes, cannabinoids, synthetic cannabinoids, mushrooms, psilocybin containing mushrooms, peyote, ayahuasca, mescaline and combinations thereof.

24. The method according to claim 23 wherein the addition provides flavor and/or physiological and/or mind altering reactions to said mixture or beverage.

25. The method according to claims 14 to 24, wherein alcohol is added to said beverage to create alcoholic beer in a time frame that is more rapid than traditional methods of fermentation.

26. The method according to claims 14 to 24, wherein wine, kombucha, seltzer, alcohol-free, non-alcoholic or alcoholic mixtures or beverages are produced in a time frame that is more rapid than traditional methods.

27. A rapid method for producing an alcoholic beverage comprising the steps of:
a. Mixing a base of malt extract and water with yeast; with or without adjuncts, hops, flavor-active materials such as spices, psychoactive materials, and/or physiologically active materials;
b. Holding the mixture, aerobically or anaerobically, for 12 hours (range 6 to 48 hours) at 30° C. (range of 0-35° C., up to 75° C.);
c. Adding maltodextrin or other adjuncts, water, lactic acid and hop solution to said mixture;
d. Removing yeast from said mixture;
e. Heating said mixture to boiling; and then
f. Cooling said mixture.

28. The method according to claim 27, wherein the beverage contains more than 0.5% ABV.

29. The method according to claims 27 to 28, wherein the amount of malt extract and adjunct are adjusted to change the body and sweetness of said beverage.

30. The method according to claims 27 to 29, wherein additional ingredients consisting of hops, spices, herbs, specialty malts or combinations thereof are added to said mixture.

31. The method according to claims 27 to 30, wherein the alcohol content of said mixture is assessed prior to heating, after heating or both.

32. The method according to claims 27 to 31 wherein, the aldehyde content and/or flavor-positive components of said mixture or beverage are controlled by varying the fermentation time.

33. The method according to claims 27 to 32, wherein the flavor of said mixture or beverage is altered by the addition of a material selected from the group consisting of hop oil, hop extract, specialty malt, natural flavor, artifical flavor and combinations thereof.

34. The method according to claims 27 to 33, wherein the flavor and/or psychoactive or physiological makeup of said mixture or beverage is altered by the addition of a material selected from the group consisting of caffeine, protein, vitamin supplements, mineral supplements, kombucha, herbs, teas, spices, beer, wine, spirits, terpenes, cannabinoids, synthetic cannabinoids, mushrooms, psilocybin containing mushrooms, peyote, ayahuasca, mescaline and combinations thereof.

35. The method according to claim 34 wherein the addition provides flavor and/or physiological and/or mind altering reactions to said mixture or beverage.

36. The method according to claims 27 to 35, wherein wine, kombucha, seltzer and other alcohol-free, non-alcoholic or alcoholic mixtures or beverages are produced in a time frame that is more rapid than traditional methods.

37. A rapid method for producing an alcoholic beverage comprising the steps of:
a. Mixing malt and water; with or without adjuncts, hops, flavor-active materials such as spices, psychoactive materials, and/or physiologically active materials;
b. Heating the mixture to at least 70° C. for at least 10 minutes, then cooling to to a range of 0-35° C.;
c. Adding yeast, with or without hops, flavor-active materials such as spices, psychoactive materials, and/or physiologically active materials and/or combinations thereof;
d. Holding the mixture, aerobically or anaerobically, for range 6-48 hours at a range of 0-75° C.;
e. Adding maltodextrin or other dextrinous compounds (adjuncts), water, lactic acid and hop solution to the mixture;
f. Removing yeast from the mixture;
g. Heating the mixture to boiling; and then
h. Cooling said mixture.

38. The method according to claim 37, wherein the beverage contains more than 0.5% ABV.

39. The method according to claims 37 to 38, wherein the amount of malt extract and adjunct are adjusted to change the body and sweetness of said beverage.

40. The method according to claims 37 to 39, wherein adding additional ingredients consisting of hops, spices, herbs, specialty malts or combinations thereof are added.

41. The method according to claims 37 to 40, wherein the alcohol content is assessed prior to heating, or after heating or both.

42. The method according to claims 37 to 41 wherein, the aldehyde content and/or flavor-positive components of said beverage are controlled by varying the fermentation time.

43. The method according to claims 37 to 42, wherein the flavor of said beverage is altered by the addition of a material selected from the group consisting of hop oil, hop extract, specialty malt, natural flavor, artifical flavor and combinations thereof.

44. The method according to claims 37 to 43, wherein the flavor and/or psychoactive or physiological makeup of said beverage is altered by the addition of a material selected from the group consisting of caffeine, protein, vitamin supplements, mineral supplements, kombucha, herbs, teas, spices, beer, wine, spirits, terpenes, cannabinoids, synthetic cannabinoids, mushrooms, psilocybin containing mushrooms, peyote, ayahuasca, mescaline and combinations thereof.

45. The method according to claim 44 wherein the addition provides flavor and/or physiological and/or mind altering reactions.

46. The method according to claims 37 to 45, wherein wine, kombucha, seltzer and other alcohol-free, non-alcoholic or alcoholic mixtures or beverages are produced in a time frame that is more rapid than traditional methods.

47. A rapid method for producing an alcoholic beverage comprising the steps of:
a. Mixing malt and water; with or without adjuncts, hops, flavor-active materials such as spices, psychoactive materials, and/or physiologically active materials;
b. Heating the mixture to a range of 40-65° C. for a range of 5 to 90 minutes, increasing temperature to a range between 70-80° C. for 2-15 minutes, then cooling to 0-35° C.;
c. Adding yeast, with or without hops, flavor-active materials such as spices, psychoactive materials, and/or physiologically active materials to said mixture;
d. Holding said mixture, aerobically or anaerobically, for 6-48 hours at 0-75° C.;
e. Removing yeast from said mixture;
f. Heating said mixture to boiling; and then
g. Cooling said mixture.

48. The method according to claim 47, wherein said mixture contains more than 0.5% ABV.

49. The method according to claim 47, wherein adding: maltodextrin or other dextrinous compounds (adjuncts), water, lactic acid and hop solution to said following holding in step d.

50. The method according to claims 47 to 49, wherein the amount of malt extract and adjuncts are adjusted to change the body and sweetness of said mixture.

51. The method according to claims 47 to 50, wherein additional ingredients consisting of hops, spices, herbs, specialty malts or combinations thereof are added to said mixture.

52. The method according to claims 47 to 51, wherein the alcohol content of said mixture is assessed prior to heating, or after heating or both.

53. The method according to claims 47 to 52 wherein, the aldehyde content and/or flavor-positive components of said mixture are controlled by varying the fermentation time.

54. The method according to claims 47 to 53, wherein the flavor of said mixture is altered by the addition of a material selected from the group consisting of hop oil, hop extract, specialty malt, natural flavor, artifical flavor and combinations thereof.

55. The method according to claims 47 to 54, wherein the flavor and/or psychoactive or physiological makeup of said mixture is altered by the addition of a material selected from the group consisting of caffeine, protein, vitamin supplements, mineral supplements, kombucha, herbs, teas, spices, beer, wine, spirits, terpenes, cannabinoids, synthetic cannabinoids, mushrooms, psilocybin containing mushrooms, peyote, ayahuasca, mescaline and combinations thereof.

56. The method according to claim 55 wherein the addition provides flavor and/or physiological and/or mind altering reactions to said mixture.

57. The method according to claims 47 to 56, wherein wine, kombucha, seltzer and other alcohol-free, non-alcoholic or alcoholic mixtures or beverages are produced in a time frame that is more rapid than traditional methods.
